(19) United States
(12) Patent Application Publication
(10) Pub. No.: US 2006/0087104 A1
(43) Pub. Date: Apr. 27, 2006

(54) Multi-use boat trailer

(76) Inventor: John R. Williams, Madras, OR (US)

Correspondence Address: GLENN C. BROWN, PC, 777 NW WALL STREET, SUITE 308, BEND, OR, 97701, US

(21) Appl. No.: 10/972,038

(22) Filed: Oct. 21, 2004

(51) Int. Cl. B62B 1/00

(52) U.S. Cl. 280/656

(57) ABSTRACT

A vehicle trailer includes a first section and a second section next to the first section. The first section accommodates a boat or a personal water craft, and the second section accommodates at least one second item. The at least one second item may be a motorcycle or an ATV. The second section may accommodate two motorcycles or one motorcycle and one ATV. The second section is optionally enclosed. The layout of the tie down anchors in the second section is customizable.

### BACKGROUND OF THE INVENTION

1. Technical Field

The present invention relates generally to a trailer for transporting multiple items. For example, the trailer can transport a boat and one or more motorcycles.

2. Field of the Invention

A typical boat trailer does not include space for additional items. Therefore, a problem with typical boat trailers is that they are not versatile since the only function is to transport a boat.

In some circumstances where it is desirable to transport other vehicles in addition to the boat, an upper deck is added to the trailer so that a boat may be transported on either the upper deck or the lower deck and the other vehicle may be transported on the other deck. A problem with these multi-use trailers is that they are difficult to load and unload.

### BRIEF SUMMARY OF THE INVENTION

Accordingly, one object of the present invention is to provide a trailer for transporting and launching a boat or other personal water craft. In addition to the personal water craft holding section of the trailer, the trailer also includes a deck for transporting additional vehicles or items. The additional vehicles or items can remain on the trailer during launching of the personal water craft.

Another object of the present invention is to provide a trailer with the versatility to carry several different types of vehicles.

Yet another object of the present invention is to provide a trailer that is easy to load and unload.

Still another object of the present invention is to provide a trailer with customizable mounting options.

### BRIEF DESCRIPTION OF THE DRAWINGS

The nature, principle and utility of the present invention will be clearly understood from the following detailed description when read in conjunction with the accompanying drawings, wherein:

FIG. 1 is a top view of a first embodiment of the trailer.

FIG. 2 is a side view of trailer shown in FIG. 1.

FIG. 3 is a top view of a second embodiment of the trailer.

FIG. 4 is a side view of a third embodiment of the trailer.

FIG. 5 is a side view of a fourth embodiment of the trailer.

The drawings are for illustrative purposes only and are not drawn to scale. In the drawings, the same numbers are used for the same part or portion throughout the drawings.

### DETAILED DESCRIPTION OF THE INVENTION

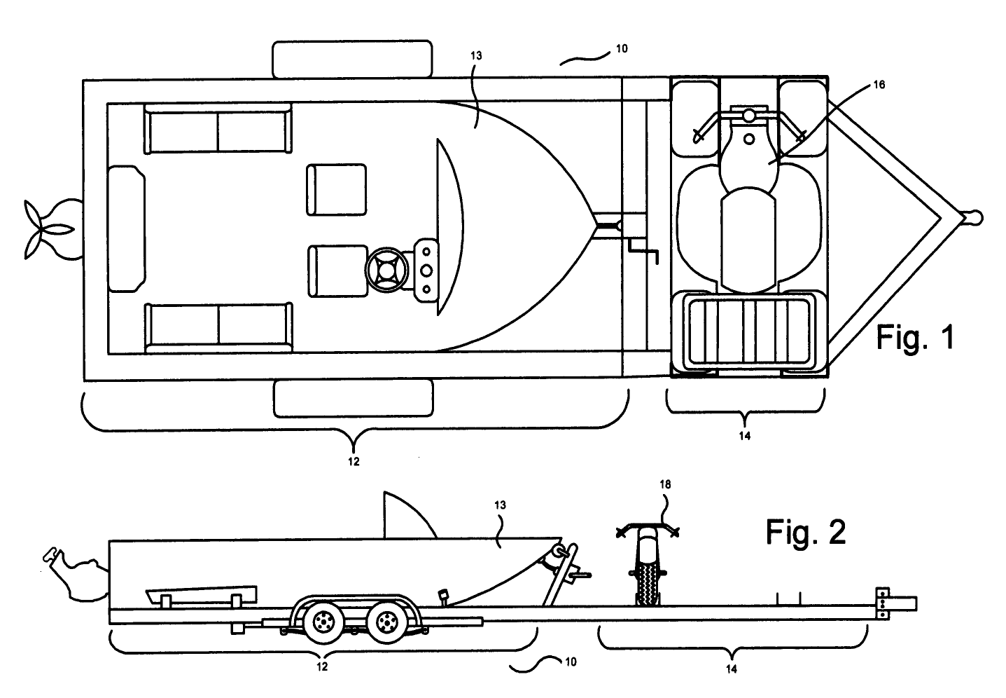

A first embodiment of the present invention is shown in FIGS. 1 and 2, wherein FIG. 1 is the top view and FIG. 2 is the side view. The trailer 10 includes a section 12 for supporting a boat 13 and a section, or deck, 14 for supporting another vehicle. The deck 14 is designed to support many different kinds of items. For example, in FIG. 1, an ATV 16 is transported on deck 14, whereas, in FIG. 2, a motorcycle 18 is shown in section 14. Alternatively, the deck portion 14 of the trailer 10 could be used for transporting gear or other types of vehicles. In addition, the mounting options on the deck 14 are customizable, as discussed below.

For launching purposes, it is desirable to position the boat section 12 as the rear section of the trailer 10. However, other configurations could be used as well. For example, the boat section 12 could be in the front of the trailer and the deck 14 could be in the rear of the trailer.

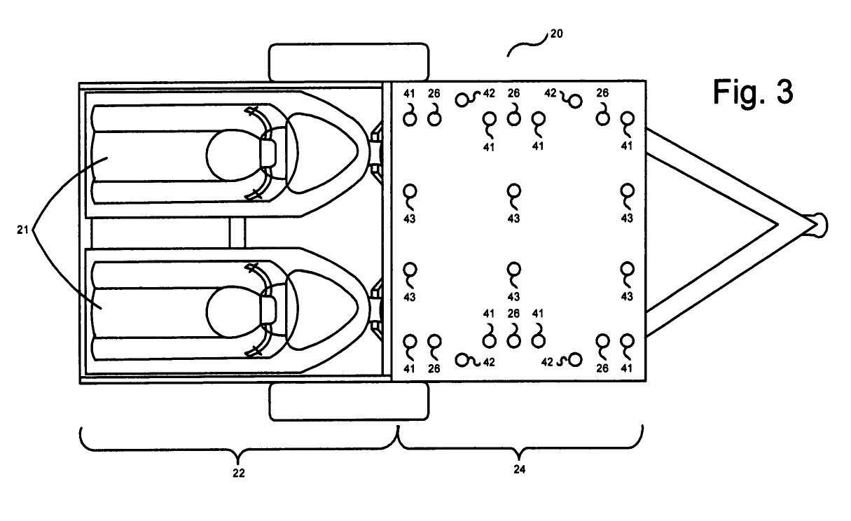

FIG. 3 shows an alternative arrangement for the trailer 20. In FIG. 3, the trailer 20 is depicted as carrying two personal water crafts 21 in section 22. Alternatively, section 22 could be used to transport only one personal water craft. Section 24 of the trailer 20 includes tie down anchors 26, 41, 42, 43 to accommodate several different types of vehicles. The mounting options on the deck portion of the trailer are customizable in that the deck portion may include one or more of the following mounting options. Tie down anchors 26 can accommodate up to two motorcycles. Tie down anchors 41 can accommodate up to three motorcycles. Tie down anchors 42 can accommodate up to two ATVs. Tie down anchors 43 provide additional support to the ATV tie down anchors 42 and are optional. Other mounting options are also possible.

The deck section of the trailer is also customizable in that it could be almost any size. The size and mounting options are variable and can be customized depending on the needs of the user.

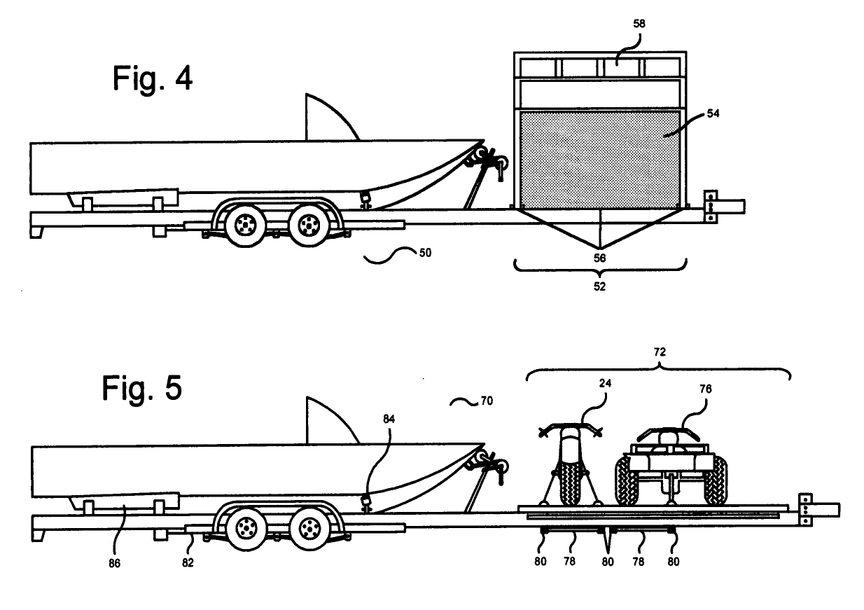

FIG. 4 shows the deck portion 52 of the trailer 50 as being enclosed. In this example, the enclosure includes a ramp 54 which is attached to the base of the trailer by hinges 56. Thus, the ramp 54 can be folded down and up, making loading and unloading of the deck section 52 easier. The enclosure also includes a storage area 58 for gear, fuel, etc. One of the benefits of the enclosure is that it can be locked down.

In the embodiment shown in FIG. 5, the deck portion 72 of the trailer 70 is arranged so that the tie down anchors can accommodate a motorcycle 74 and an ATV 76. The deck section 72 also includes ramps 78 that are stored under the trailer 70. The ramps 78 are held in place by channels 80. When needed, the ramps 78 can slide out of the channels 80 and one end of the ramp 78 is hooked onto the trailer to facilitate loading and unloading.

In all of the embodiments discussed above, the axle carriage 82 (FIG. 5) can slide forwards or backwards to accommodate weight variances. In addition, the size, shape and position of the roller 84 and skids 86 (FIG. 5) will vary based on the boat or other personal water craft that is to be towed.

While the invention has been described by reference to the preferred embodiments described above those skilled in the art will recognize that the invention as described and illustrated can be modified in arrangement and detail without departing from the scope of the invention.

What is claimed is:

1. A vehicle trailer comprising:
a first section; and
a second section next to the first section,
wherein the first section accommodates a boat or a personal water craft, and
wherein the second section accommodates at least one second item.

2. A vehicle trailer according to claim 1, wherein the at least one second item is a motorcycle or an ATV.

3. A vehicle trailer according to claim 1, wherein the second section is enclosed.

4. A vehicle trailer according to claim 1, wherein the second section comprises tie down anchors.

5. A vehicle trailer according to claim 4, wherein a layout of the tie down anchors is customizable.

6. A vehicle trailer according to claim 2, wherein the second section accommodates two motorcycles.

7. A vehicle trailer according to claim 2, wherein the second section accommodates one motorcycle and one ATV.
